(19) United States
(12) Patent Application Publication
(10) Pub. No.: US 2025/0011680 A1
(43) Pub. Date: Jan. 9, 2025

(54) NOVEL METHOD FOR REMOVAL OF INORGANIC CHLORIDE COMPOUNDS FROM A FEEDSTOCK

(71) Applicant: Neste Oyj, Espoo (FI)

(72) Inventors: Yi Yin CHEE, Porvoo (FI); Sari MUSCH, Porvoo (FI); Jukka-Pekka PASANEN, Porvoo (FI); Annika MALM, Porvoo (FI); Sami ALAKURTTI, Porvoo (FI)

(73) Assignee: Neste Oyj, Espoo (FI)

(21) Appl. No.: 18/724,934

(22) PCT Filed: Dec. 29, 2022
(86) PCT No.: PCT/EP2022/088007

§ 371 Date: Jun. 27, 2024

(30) Foreign Application Priority Data
Dec. 30, 2021 (FI) 20216367

(51) Int. Cl. C11B 3/10; B01J 20/10; C11B 3/00; C11B 3/04

(52) U.S. Cl. CPC C11B 3/10; B01J 20/10; C11B 3/001; C11B 3/008; C11B 3/04

(57) ABSTRACT

The present disclosure relates to a novel process for removing or reducing inorganic and organic chloride containing compounds from a feedstock.

### FIELD OF THE INVENTION

Present invention relates to the field of processing and purifying a feedstock. Specifically, the invention solves the problem of removing or reducing chloride containing compounds from a feedstock. The feedstock may be of any plant or animal origin and lipids therefrom. Present invention also relates to a purified feedstock obtainable by the method according to the invention.

### BACKGROUND OF THE INVENTION

US2020384396 relates to compositions and methods for filtering oil, e.g., for removing free fatty acids (FFAs) from an oil used for cooking. In one example, the composition may comprise a filter aid that includes an alkali silicate, and a composite material comprising a silicate mineral at least partially coated with an inorganic silica or silicate. In another example, filter aid includes an alkali silicate, and a silicate mineral, wherein at least a portion of the alkali silicate is present as a coating on the silicate mineral.

WO16054597 discloses processes and system for producing biofuels and coproducts. The processes include pre-treating a feedstock comprising fatty acid glycerides and free fatty acids to remove impurities, contaminants, or other components of the feedstock stream that can damage the catalyst and/or shorten catalyst life. In some embodiments, impurities such as metals and peroxides are removed by a mechanical device, for example a filter. In some embodiments, filtering may also include the use of a filter aid, such as alumina, silica, bleaching clays and/or diatomaceous earth (DE). In some embodiments, the filter is pre-coated with a filter aid, such as silica may be added, and the impurity (e.g., a metal) absorbs onto the filter aid and are trapped by the filter. In the examples, temperatures vary between 85° C. and 216° C.

### SUMMARY OF THE INVENTION

As discussed herein, present invention relates to a method of removing or reducing chloride containing compounds from a feedstock.

Essentially, the process may comprise the steps of:
i) providing a feedstock comprising a lipid material,
ii) optionally subjecting the feedstock to a drying step,
iii) contacting said feedstock with a silicon or mineral based material,
iv) separating the feedstock from the silicon or mineral based material.

The overall aim with the invention is to provide a method or process for removing or reducing chloride containing compounds from a feedstock such that in one aspect the obtained feedstock is essentially free of any inorganic chloride compounds, or having reduced amounts of inorganic chloride compounds.

In a further aspect, the invention provides a method or process avoiding or reducing formation of organic chloride compounds and consequently not contributing to increasing the amount of organic chloride compounds of the purified feedstock in relation to the unpurified or unprocessed feedstock. Thus, in one aspect the process according to the invention does not increase the organic chloride content by more than 10 ppm in comparison with unpurified feedstock. In another aspect, the organic chloride content in the purified feedstock is equal to the amount of the same in the unpurified feedstock.

In yet a further aspect, present invention relates to i) providing a feedstock comprising a lipid material,
ii) optionally subjecting the feedstock to a drying step,
iii) contacting said feedstock with a silicon or mineral based material in an amount of 0.1 wt % to 5 wt % based on the content of the weight of the feedstock, and optionally the contacting takes place in a temperature range of 15° C. to 120° C., for example for a period of time 1 minute to 360 min, optionally at a reduced pressure of about 1000 mbar or below about 1000 mbar,
iv) separating the feedstock from the silicon or mineral based material.

In one aspect, the process according to the invention may in principle be performed at about atmospheric pressure (1 atm; 101.3 kPa) or below atmospheric pressure. Thus, in one aspect, step iii) may be performed at about atmospheric pressure (1 atm; 101.3 kPa) or below atmospheric pressure. In yet a further aspect, step iii) may be performed above atmospheric pressure.

In one aspect, present invention relates to removal or reduction of chloride containing compounds from a feedstock. The chloride containing compound could in principle be any compound, organic or inorganic compound, which comprises at least one chloride atom in its chemical formula. In one aspect, the chloride containing compound may be any chloride compound of an alkali metal or alkaline earth metal, such as e.g. NaCl, KCl, CaCl₂, MgCl₂ etc. In another aspect, the invention also aims at reducing the amount or formation of organic chloride compounds. In yet a further aspect, the invention relates to removal or reduction of the total content of chloride in a feedstock and consequently relates to removal or reduction of the amount of both inorganic and organic chloride compounds.

As will be further elaborated upon, the invention aims at reducing the amount of both organic and inorganic chloride compounds present in a feedstock, which in the context of the invention is intended to mean the sum of inorganic and organic chloride compounds present in a feedstock.

The feedstock according to present invention may be of any plant or animal origin and may thus be based on any parts, derivatives or products based on any plants or animals, or any products originating from or based on algae or microbial oils.

According to the invention, the silicon or mineral based material may in some instances act as an adsorbent material which may in principle be any type of mineral-based adsorbent material. The mineral- or silicon based material may be in any form e.g. as a solid e.g. powder, granules, beads, or mixed with a liquid e.g. suspension or as a gel.

In one aspect, the silica based compound may be any type of silica gel, which may be an amorphous and porous form of silicon dioxide (silica), consisting of an irregular tridimensional framework of alternating silicon and oxygen atoms with nanometer-scale voids and pores. The voids may contain water or some other liquids, or may be filled by gas or vacuum (also referred to as silica xerogel).

In one aspect, any suitable mineral-based material may be used. In another aspect, the silicon based material is amorphous silica, such as e.g. preferably Trisyl.

A silicon and/or mineral based material used in the present invention can be regarded as a filter aid. Filter aids may be powdery or fibrous substances that make a filter cake porous. Therefore, filter aids can improve the filtration flow. For example, a filter aid may be selected from mineral based or silicon based filter aids or wood fiber filter aids such as cellulose based filter aids. In one aspect, a filter aid such as a silicon and/or mineral based material is not an adsorbent, e.g. not an acid activated material such as not an acid activated mineral based material. In one aspect, a silicon and/or mineral based material of the present invention can be used for removing solid materials (such as inorganic chlorine) from a feedstock and not for changing any inorganic substance to an organic substance. In one aspect of the invention the aim is to remove inorganic chlorine so that the total chlorine content of the feedstock is decreased. Thus, preferably inorganic chloride containing compound is not converted into organic chlorine containing compounds.

The obtained purified feedstock may be essentially free of any chloride containing compound such as inorganic chlorine or may contain a reduced amount of chloride containing compounds such as inorganic chlorine. In the context of the invention, the terminology “essentially free of” any chloride compound or inorganic chloride containing compound may mean that the level of chloride compounds or inorganic chlorine compounds is below what is possible to detect with standard analytical methods or means. Thus, the purified feedstock may be 100% free of any chloride containing compounds, or may contain less than e.g. about 50% chloride containing compounds, or less than about 40%, or less than about 30%, or less than about 20%, or less than about 15%, less than about 10%, less than about 5%, less than about 3%, less than about 1%, less than about 0.5%, or less than about 0.1% chloride containing compounds compared to the original content of chloride compounds present in the feedstock before being treated by the method or process according to the invention. Thus, the purified feedstock may be 100% free of any inorganic chloride compounds, or may contain less than e.g. about 50% inorganic chloride compounds, or less than about 40%, or less than about 30%, or less than about 20%, or less than about 15%, less than about 10%, less than about 5%, less than about 3%, less than about 1%, less than about 0.5%, or less than about 0.1% inorganic chloride compounds compared to the original content of inorganic chloride compounds present in the feedstock before being treated by the method or process according to the invention.

As also mentioned herein, present invention relates to a purified feedstock obtainable by the method according to the invention.

### Definitions

By the term “feedstock” is intended to mean any material based on, comprising, consisting of, or originating from any plant or animal origin. It may also refer to any material based on, comprising, consisting of, or originating from microbial, algal or bacterial or fungal material. In one embodiment, the feedstock is from a renewable and/or organic material and/or the feedstock comprises a lipid material. The term “feedstock” or “feedstock comprising a lipid material” may also specifically comprise one or more of any plant oils, plant fats, animal fats and animal oils, and mold oils, selected from e.g. used cooking oil (UCO), rapeseed oil, canola oil, colza oil, tall oil, sunflower oil, corn oil, technical/distillers corn oil (TCO), soybean oil, hemp oil, olive oil, linseed oil, cottonseed oil, mustard oil, palm oil, palm effluent sludge (PES or also called POME), arachis oil, castor oil, coconut oil, animal fats such as e.g. suet, tallow, blubber, recycled alimentary fats, fish oil, starting materials produced by genetic engineering, and biological starting materials produced by microbes such as algae and bacteria and the likes, acidulated soapstock (acidified soapstock), trap grease, brown grease, gutter oil, fatty acid distillates (FAD) from e.g. rice bran oil or from palm oil (palm oil fatty acid distillate PFAD), or any combinations or mixtures thereof.

In one aspect, the term feedstock does not include any fossil based material.

The term “Used cooking oil (UCO)” refers to oils and fats that have been used for cooking or frying in the food processing industry, in restaurants, in fast foods and at consumer level, in households.

The term “gutter oil” is a general term for waste oils collected from sources such as fryers, grease traps, slaughterhouse waste, and fatbergs.

By the term “Brown Grease” is intended to mean any emulsion of fat, oil, grease, solids, and water separated from wastewater in a grease interceptor (grease trap) and collected for use as a fuel feedstock

The terminology “reduced” is intended to mean that a certain component is present in a lower amount in any material, such as e.g. a feedstock, in relation to its presence in any material prior to any processing or its presence in e.g. a feedstock used as a starting material or raw material in any process. A reduction may mean that one or more components are reduced by 100%, and thus is essentially completely removed, or reduced by at least about 20%, such as e.g. reduced by at least about 30%, such as e.g. reduced by at least about 40%, such as e.g. reduced by at least about 50%, such as e.g. reduced by at least about 60%, such as e.g. reduced by at least about 70%, such as e.g. reduced by at least about 80%, such as e.g. reduced by at least about 85%, such as e.g. 90%, such as e.g. at least about 95%, such as e.g. at least about 97%, such as e.g. at least about 98%, such as e.g. at least about 99%. Such percentages may be measured as weight % (wt %) or volume % (vol %) or mol %, or may be a measurement of the ratio between the remaining amount of e.g. chloride containing compounds in the purified feedstock vs. unpurified feedstock.

In one aspect, the reduction of chloride containing compounds is in range of about 40% to about 60%, such as e.g. about 50%.

The terminology “silica based” compound or material is intended to mean any compound or material containing a silicon atom. Such compounds may be silicon oxide based compounds such as e.g. silicon dioxide based compounds. Further examples are e.g. silica gels or silica xerogels in any form or configuration. Further non-limiting example is e.g. silica alumina gel. Several varieties of silica based compounds exist on the market such as e.g. Trisyl® etc. which are also included in the terminology.

In the context of the invention, the terminology “mineral based” material is intended to mean, but not limited to, any material comprising or consisting of e.g. diatomaceous earth, diatomite, perlite, bentonite, palygorskite, kaoline, kaolinite, silica in various crystalline or amorphous configurations, sepiolite, magnesium silicate, silicon, aluminium or zinc oxide based materials, neutral bleaching earth, activated carbon, activated charcoal, or any combinations thereof. The mineral based material may be activated by means known in the art, such as activated by an acid and thus have an acidic nature.

In one aspect, any type of cellulose based material may be used instead of a mineral or silicon based material.

In one aspect, the mineral based material has not been or is not acid activated, i.e. has not been treated with any acid.

In a further aspect, the mineral based material has at least a neutral pH or above neutral pH. Non-limiting examples of the pH of the mineral based material is a pH in range of at least of about 6.0 to about 13, such as e.g. at least about 7.0, or at least about 7.5, or at least about 8.0, or at least about 8.5, at least about 9.0, at least about 9.5, at least about 10.0, at least about 10.5, at least about 11.0, at least about 11.5, or at least about 12.0, or at least about 12.5 etc. In a further aspect, the mineral based material may have a pH in range of about 8.0 to about 12, or in range of about 8.3 to about 11.4.

In one aspect, the silica based material may have a lower pH such as e.g. about 3.0 to about 5.0, such as e.g. about 3.5, or such as e.g. about 4.0, such as e.g. about 4.5, such as e.g. about 5.0 etc.

### DETAILED DESCRIPTION OF THE INVENTION

As mentioned above, present invention relates to a method of removing or reducing the total chloride containing compounds from a feedstock (inorganic and organic chloride compounds in total). Specifically, the invention relates to reduction or removal of inorganic chloride compounds.

Present invention provides for a method enabling use of a feedstock for the preparation of other raw materials such as e.g. fuels and chemicals. Present invention thus provides for a simple and effective processing of a feedstock for removal of chloride containing compounds and thus presents a method for use of renewable raw material. Present invention solves the problem with corrosive materials that may be present in a feedstock. Specifically, present invention provides for a method or process wherein chloride containing compounds are reduced or removed which in turn removes or reduces the amount of e.g. hydrochloric acid formation in the processing of a feedstock. This may arise from e.g. hydrogenation of inorganic chloride compounds. Such corrosive materials may affect e.g. piping or tubing in process machinery, which may in turn directly, or indirectly entail increased costs of production.

High concentrations of inorganic chloride can be present especially in e.g. low quality UCOs. Inorganic chloride is not removed during bleaching, but it is converted under acidic bleaching conditions to organic chloride (organic compounds containing at least one chloride atom), which is very difficult to remove. Both inorganic and organic chlorides cause severe corrosion risk to process equipment, such as e.g. piping, tubing or processing or reaction chambers. Thus, there is a need for an effective removal process to reduce inorganic chloride prior to bleaching. Moreover, there is a large supply potential of unutilised UCO and trap grease feeds, which cannot be purchased and utilised due to the too high chloride levels. Consequently, present invention provides for a novel and effective solution to this problem enabling use of feedstocks that are generally considered unsuitable for any further use as raw material for production of e.g. fuels or chemicals. In terms of effectiveness, present invention capitalises on e.g. the omission of process steps that would entail extra handling or energy cost. Thus, present invention may be suitable for large scale industrial processing.

One of obtained effects by present process is a decreased filterability resistance (which may be expressed and measured as GPas/kg²), and/or a decreased filtration time (which may be measured and expressed in minutes) in the processing of the feedstock.

In one aspect, the method or process according to the invention may comprise or consist of the steps of:
i) providing a feedstock comprising a lipid material,
ii) optionally subjecting the feedstock to a drying step,
iii) contacting said feedstock with a silicon or mineral based material,
iv) separating the feedstock from the silicon or mineral based material, to thereby obtain a feedstock which is essentially free of any inorganic chloride compounds, or having reduced amounts of inorganic chloride compounds.

In another aspect, present invention may comprise a two-stage process, wherein the process may comprise a first stage essentially comprising the steps of;
i) providing a feedstock comprising a lipid material,
ii) optionally subjecting the feedstock to a drying step,
iii) contacting said feedstock with a silicon or mineral based material,
iv) separating the feedstock from the silicon or mineral based material, and followed by a second stage which may comprise bleaching the separated feedstock from step iv).

In one aspect, the process may include extra reaction or treatment steps prior to, in between, and/or after steps i)-iv).

In yet a further aspect, the process may not include e.g. a hydrolysis step.

In another aspect, present invention may not employ any catalyst with the purpose to catalyse any chemical reaction between any reactants.

The feedstock according to the invention may in principle be any material based on, comprising, or consisting of, or originating from any plant or animal origin. Thus, the feedstock may be also be based on, comprising or consisting of any microbial, algae or bacteria or fungal material. Non-limiting examples may be any plant oils, plant fats, fish oils, fish fats, animal fats and animal oils, waste fats, waste oils, residue fats, residue oils, and mold oils, selected from e.g. rapeseed oil, canola oil, colza oil, tall oil, sunflower oil, corn oil, technical/distillers corn oil, soybean oil, hemp oil, olive oil, linseed oil, cottonseed oil, mustard oil, palm oil, palm effluent sludge (PES, which is also mentioned as palm oil mill effluent oil-POME), or sludge originating from any type of plant oil production, arachis oil, castor oil, coconut oil, animal fats such as e.g. suet, tallow, blubber, fish oil, recycled alimentary fats, used cooking oil (UCO), acidulated soapstock (acidified soapstock), trap grease, brown grease, gutter oil, Fatty Acid Distillates (FAD) from e.g. rice bran oil or from palm oil (palm oil fatty acid distillate PFAD), starting materials produced by genetic engineering, and biological starting materials produced by microbes such as algae and bacteria and the likes or any combinations or mixtures thereof. It should be noted that acidulated soapstock is also known as acidified soapstock (ASK, which is also mentioned as soapstock acid oil-SAO), which is the product obtained from complete acidulation and thorough setting of soapstock, which itself is the by-product obtained from alkali refining of crude oils and fats.

In another aspect, the feedstock according to the invention may be plant oils, plant fats, animal fats, animal oils, fish fats, fish oils, microbial oils, algae oils, waste fats, waste oils, residue fats, residue oils, a sludge originating from plant oil production, a fatty acid distillate, acidulated soapstock, mold oils, rapeseed oil, canola oil, colza oil, babassu oil, carinata oil, coconut butter, muscat butter oil, sesame oil, maize oil, poppy seed oil, cottonseed oil, soy oil, laurel seed oil, jatropha oil, palm kernel oil, camelina oil, tall oil, fraction of tall oil, crude tall oil, tall oil pitch, sunflower oil, corn oil, technical/distillers corn oil (TCO), soybean oil, hemp seed oil, olive oil, linseed oil, cottonseed oil, mustard oil, mustard seed oil, peanut oil, castor oil, coconut oil, palm oil, crude palm oil, palm seed oil, palm fatty acid distillate, palm oil mill effluent, arachis oil, castor oil, coconut oil, archaeal oil, bacterial oil, fungal oil, protozoal oil, algal oil, seaweed oil, oils from halophiles, poultry fat, dry rendered poultry fat, brown grease, used cooking oil, suet, lard, tallow, blubber, recycled alimentary fats, acid oil, train oil, spent bleaching earth oil, lignocellulosic based feeds, materials produced by genetic engineering, and biological materials produced by microbes, or any combinations or mixtures thereof.

In a particular aspect, the feedstock may comprise used cooking oil (UCO).

In yet a further aspect, the feedstock may comprise one or more of acidulated soapstock (acidified soapstock), trap grease, brown grease, gutter oil, Fatty Acid Distillates (FAD) from e.g. rice bran oil or from palm oil (palm oil fatty acid distillate PFAD).

The feedstock according to present invention comprises relatively high levels of chloride containing compounds prior to being subjected to the method or process according to present invention. In one aspect, the feedstock comprises an inorganic chloride content equal to or more than about 30 ppm, such as e.g. about 35 ppm or more, and a total chloride content equal to or more than about 50 ppm.

In one aspect, the invention relates to an optional drying of the feedstock as illustrated in step ii). The purpose of the drying step is to reduce the amount of water present in the feedstock. It is to be clearly understood that the terminology “optional” is intended to mean that the process step may or may not be included in the overall process or method of the invention.

In one aspect, the drying step ii) is included in the overall process or method of the invention.

In another aspect, the overall process or method does not include a drying step as illustrated in step ii).

In one aspect, the optional drying step ii) may comprise treating the feedstock at an elevated temperature. Such temperature may be any temperature above ambient temperature, such as e.g. in the range of in the range of about 30° C. to about 200° C., such as e.g. in the range of in the range of about 35° C. to about 150° C., such as e.g. in the range of in the range of about 40° C. to about 130° C., such as e.g. in the range of in the range of about 50° C. to about 120° C., such as e.g. in the range of in the range of about 60° C. to about 100° C., such as e.g. in the range of in the range of about 70° C. to about 90° C., or about 40° C., about 50° C., about 60° C., about 70° C., about 80° C., about 90° C., about 100° C., about 110° C., about 120° C., about 130° C., about 140° C., about 150° C., about 160° C., about 170° C., about 180° C., about 190° C., or about 200° C.

In one aspect, the drying step may comprise treatment at a temperature of about 90° C. to about 110° C., preferably about 105° C.

The optional drying step ii) may also comprise treatment of the mixture and at reduced pressure. The reduced pressure may in principle be a reduced pressure under normal pressure (1 atm, standard atmospheric pressure corresponding to 1013.25 mbar), such as e.g. at a pressure of about 100 mbar to about 900 mbar, such as e.g. about 200 mbar to about 900 mbar, such as e.g. about 300 mbar to about 900 mbar, such as e.g. about 400 mbar to about 900 mbar, such as e.g. about 500 mbar to about 900 mbar, such as e.g. about 600 mbar to about 900 mbar, such as e.g. about 700 mbar to about 900 mbar, or preferably about 800 mbar, or alternatively at least at 90 mbar, such as e.g. at least 80 mbar, such as e.g. at least 70 mbar, such as e.g. at least 60 mbar, such as e.g. at least 50 mbar, such as e.g. at least 40 mbar, such as e.g. at least 30 mbar, such as e.g. at least 20 mbar, such as e.g. at least 10 mbar, such as e.g. at least 5 mbar, such as e.g. at least 1 mbar.

In one aspect, the reduced pressure may be about 50 mbar to about 120 mbar, or preferably about 80 mbar, or even more preferably about 100 mbar.

The optional drying step ii) may be conducted for any suitable period of time or until deemed sufficient to remove a desired amount of water or until the remaining amount of water left in the mixture is deemed acceptable. Such period of time may be for a time period of about 5 min to about 90 minutes, preferably about 20 min or about 60 min. Or alternatively for up to about 6 h, such as e.g. up to about 5 h, such as e.g. up to about 4 h, such as e.g. up to about 3 h, such as e.g. up to about 2 h, such as e.g. up to about 90 minutes, such as e.g. up to about 80 minutes, such as e.g. up to about 70 minutes, such as e.g. up to about 60 minutes, such as e.g. up to about 50 minutes, such as e.g. up to about 40 minutes, such as e.g. up to about 30 minutes, such as e.g. up to about 20 minutes, such as e.g. up to about 10 minutes, such as e.g. up to about 5 minutes.

In one aspect, the period of time may be during any time period of about 5 min to about 60 min, or preferably about 15 min or about 45 min.

According to the invention, the process or method comprises contacting the feedstock with one or more silicon or mineral based materials as illustrated in step iii). The contacting or mixing must provide for a contact between the silicon or mineral based material and feedstock. Contacting or mixing may be effected by e.g. any type of mechanical stirring or agitation, or e.g. high shear mixing.

The silicon or mineral based material may be added in an amount of about 0.1 wt % to about 5 wt %, preferably about 0.3 wt % or about 1 wt %, based on the weight of the feedstock.

In one aspect, the mixing or contacting between the feedstock and the silicon or mineral based material may take place at any suitable temperature, such as e.g. in the range of about 15° C. to about 120° C., or about 15° C. to about 95° C., about 50° C. to about 90° C., about 60° C. to about 95° C., or about 70° C. to about 90° C., or about 80° C. to about 90° C., or about 85° C., or about 75° C., or less than about 100° C. or less than about 90° C.

In one aspect, the feedstock is preheated to a desired temperature prior to being contacted with the silicon or mineral based material.

In yet a further aspect, the feedstock is contacted with the silicon or mineral based material and thereafter heated to the desired temperature.

In one aspect, the feedstock is heated to a temperature of about 85° C. prior to addition of the adsorbent, or heated to about 85° C. after being mixed or contacted with the silicon or mineral based material.

According to the invention, the feedstock mixture is intended to mean a mixture comprising the feedstock in combination or contact with the silicon or mineral based material.

Optionally, in one aspect, the invention relates to including or combining the silicon or mineral based material with a filter device which may be e.g. a grid, or a net, or a porous glass disk, or a paper/cellulose based material, or a membrane of any kind or based on any material such as e.g. a polymer based membrane.

In one aspect, the silicon or mineral based material used in the present invention is a filter aid or comprises a filter aid. In some aspects, a filter device is or has been pre-coated with the filter aid or one or more filter aids before filtration.

In one aspect, the filter device may be pre-coated with the silicon or mineral based material.

In a further aspect, the contacting between the feedstock and the silicon or mineral based material may take place for a period of between about 30 seconds to about 1 h, such as e.g. about 30 minutes, such as e.g. about 20 minutes, such as e.g. about 15 minutes, such as e.g. about 10 minutes, such as e.g. about 5 minutes, such as e.g. about 3 minutes, such as e.g. about 1 minute prior to addition and mixing in with the adsorbent.

In one aspect, the contacting time between the feedstock and the silicon or mineral based material may be e.g. about 20 min.

Thus in one aspect, the feedstock mixture is heated to about 85° C. for about 20 min.

The contacting between the feedstock and the silicon or mineral based material may be conducted under increased (e.g. slightly increased) or reduced pressure compared to the standard atmospheric pressure, or alternatively at about normal pressure (1 atm). The reduced pressure may in principle be a reduced pressure under normal pressure (1 atm, standard atmospheric pressure corresponding to 1013.25 mbar), such as e.g. at a pressure of about 100 mbar to about 900 mbar, such as e.g. about 200 mbar to about 900 mbar, such as e.g. about 300 mbar to about 900 mbar, such as e.g. about 400 mbar to about 900 mbar, such as e.g. about 500 mbar to about 900 mbar, such as e.g. about 600 mbar to about 900 mbar, such as e.g. about 700 mbar to about 900 mbar, or preferably about 800 mbar. In one aspect, contacting in step iii) takes place under reduced pressure, such as e.g. about 1000 mbar, such as e.g. below about 1000 mbar, such as e.g. about 900 mbar, such as e.g. about 800 mbar, such as e.g. about 700 mbar, such as e.g. about 600 mbar, such as e.g. about 500 mbar, such as e.g. about 400 mbar, such as e.g. about 300 mbar, such as e.g. about 200 mbar, such as e.g. about 100 mbar, or under any reduced pressure in range of e.g. about 100 mbar to about 1000 mbar, e.g. more than 100 mbar to about 1000 mbar. Reduced pressure under normal pressure enables removal of air from the process or a reactor wherein the process step is carried out.

In one aspect, contacting in step iii) takes place under slightly increased pressure such as e.g. about 1013.25 mbar-2000 mbar, such as e.g. about 1013.25 mbar-1900 mbar, such as e.g. about 1013.25 mbar-1800 mbar, such as e.g. about 1013.25 mbar-1700 mbar, such as e.g. about 1013.25 mbar-1600 mbar, such as e.g. about 1013.25 mbar-1500 mbar, such as e.g. about 1013.25 mbar-1400 mbar, such as e.g. about 1013.25 mbar-1300 mbar, such as e.g. about 1013.25 mbar-1200 mbar, such as e.g. about 1013.25 mbar-1100 mbar. In one aspect, contacting in step iii) takes place under standard atmospheric pressure.

In one aspect, contacting between the feedstock and the silicon or mineral based material may be conducted under reduced pressure of about 800 mbar.

After contacting the feedstock with the silicon or mineral base material, optionally used together with a filter aid, the silicon or mineral based material is separated from the treated feedstock as illustrated in step iv). Separation may take place by any suitable method known in the art. Non-limiting examples of this may be e.g. by filtration, settling, decantation, centrifugation, and the likes, or any combinations thereof.

In one aspect, separation may take place by e.g. filtration.

In one aspect, the separated feedstock may optionally be subjected to a bleaching and/or degumming step. The bleaching step may be conducted by employment of any suitable bleaching clay or an organic acid that may be capable of chelation. Bleaching clays may be any type of e.g. various type of hydrated aluminium silicates or bleaching earths such as e.g. bentonite, attapulgite and sepiolite. Such material may be acid activated. The activation with an acid may be e.g. by the aid of sulphuric acid or hydrochloric acid.

Suitable acids that may be employed in the bleaching process are e.g., but not limited to, citric acid, oxalic acid or fumaric acid, or other suitable organic acids.

In one aspect, bleaching clays may be used in combination with an organic acid in bleaching of the obtained feedstock.

In one aspect, the bleaching material, such as e.g. the bleaching clays mentioned herein may be acid treated or otherwise activated. Acid activation may be by the aid of e.g. an inorganic acid such as e.g., but not limited to, sulphuric acid or hydrochloric acid.

In a further aspect, the bleaching material, such as e.g. the bleaching clays mentioned herein may have an acidic pH. Non-limiting examples of such pH levels are e.g. in range of about 2.5 to about 4.0, such as e.g. about 3.0, or about 3.5, or about 2.7 to about 3.8.

The bleaching may take place under the same conditions as the contacting between the feedstock and the silicon or mineral based material as seen in step iii).

Thus in one aspect, the bleaching may take place at any suitable temperature, such as e.g. in range of about 15° C. to about 120° C., or about 50° C. to about 90° C., about 60° C. to about 95° C., or about 70° C. to about 90° C., or about 80° C. to about 90° C., or about 85° C., or about 75° C. Preferably about 85° C.

Furthermore, the bleaching may take place for a period of between about 30 seconds to about 1 h, such as e.g. about 30 minutes, such as e.g. about 20 minutes, such as e.g. about 15 minutes, such as e.g. about 10 minutes, such as e.g. about 5 minutes, such as e.g. about 3 minutes, such as e.g. about 1 minute prior to addition and mixing in with the adsorbent.

In one aspect, the bleaching may take place during a period of e.g. about 20 min.

Thus in one aspect, the bleaching may take place at about 85° C. for about 20 min.

The bleaching may be conducted under reduced pressure. The reduced pressure may in principle be a reduced pressure under normal pressure (1 atm, standard atmospheric pressure corresponding to 1013.25 mbar), such as e.g. at a pressure of about 100 mbar to about 900 mbar, such as e.g. about 200 mbar to about 900 mbar, such as e.g. about 300 mbar to about 900 mbar, such as e.g. about 400 mbar to about 900 mbar, such as e.g. about 500 mbar to about 900 mbar, such as e.g. about 600 mbar to about 900 mbar, such as e.g. about 700 mbar to about 900 mbar, or preferably about 800 mbar.

In one aspect, the bleaching may be conducted under reduced pressure of about 800 mbar.

As mentioned herein, the bleaching step may also be a combined bleaching and degumming process under the same conditions as mentioned for the bleaching process.

Moreover, the bleaching may optionally include a further treatment step, which may be regarded as a drying step and which may comprise treating the bleaching mixture at an elevated temperature. Such temperature may be any temperature above ambient temperature, such as e.g. in the range of in the range of about 30° C. to about 200° C., such as e.g. in the range of in the range of about 35° C. to about 150° C., such as e.g. in the range of in the range of about 40° C. to about 130° C., such as e.g. in the range of in the range of about 50° C. to about 120° C., such as e.g. in the range of in the range of about 60° C. to about 100° C., such as e.g. in the range of in the range of about 70° C. to about 90° C., or about 40° C., about 50° C., about 60° C., about 70° C., about 80° C., about 90° C., about 100° C., about 110° C., about 120° C., about 130° C., about 140° C., about 150° C., about 160° C., about 170° C., about 180° C., about 190° C., or about 200° C.

In one aspect, the drying step may comprise treatment at a temperature of about 90° C. to about 110° C., preferably about 105° C.

The drying step may also comprise treatment of the mixture and at reduced pressure. The reduced pressure may in principle be a reduced pressure under normal pressure (1 atm, standard atmospheric pressure corresponding to 1013.25 mbar), such as e.g. at a pressure of about 100 mbar to about 900 mbar, such as e.g. about 200 mbar to about 900 mbar, such as e.g. about 300 mbar to about 900 mbar, such as e.g. about 400 mbar to about 900 mbar, such as e.g. about 500 mbar to about 900 mbar, such as e.g. about 600 mbar to about 900 mbar, such as e.g. about 700 mbar to about 900 mbar, or preferably about 800 mbar, or alternatively at least at 90 mbar, such as e.g. at least 80 mbar, such as e.g. at least 70 mbar, such as e.g. at least 60 mbar, such as e.g. at least 50 mbar, such as e.g. at least 40 mbar, such as e.g. at least 30 mbar, such as e.g. at least 20 mbar, such as e.g. at least 10 mbar, such as e.g. at least 5 mbar, such as e.g. at least 1 mbar.

In one aspect, the reduced pressure may be about 50 mbar to about 100 mbar, or preferably about 80 mbar.

The drying step may be conducted for any suitable period of time or until deemed sufficient to remove a desired amount of water or until the amount of water left in the mixture is deemed acceptable. Such period of time may be for a time period of about 5 min to about 90 minutes, preferably about 20 min or about 60 min. Or alternatively for up to about 6 h, such as e.g. up to about 5 h, such as e.g. up to about 4 h, such as e.g. up to about 3 h, such as e.g. up to about 2 h, such as e.g. up to about 90 minutes, such as e.g. up to about 80 minutes, such as e.g. up to about 70 minutes, such as e.g. up to about 60 minutes, such as e.g. up to about 50 minutes, such as e.g. up to about 40 minutes, such as e.g. up to about 30 minutes, such as e.g. up to about 20 minutes, such as e.g. up to about 10 minutes, such as e.g. up to about 5 minutes.

In one aspect, the period of time may be during any time period of about 5 min to about 60 min, or preferably about 15 min or about 45 min, or preferably about 10 min.

After completion of the bleaching, the resulting feedstock may be separated from e.g. the bleaching earth by e.g. filtration, sedimentation/settling, centrifugation, or decantation or any combinations thereof.

Present invention also relates to a feedstock obtainable by the method or process according to the invention.

The feedstock obtainable by the method or process according to the invention may be characterised by having an inorganic chloride content in range of from equal to or less than about 10 ppm to levels which cannot be analytically detected.

In another aspect, the feedstock obtainable by the method or process according to the invention may be characterised by having a total chloride content in range of from about equal to or less than about 25 ppm to levels which cannot be analytically detected.

In the context of the invention, it is to be understood that the terminology “total chloride content” relates to the sum of the amount of inorganic chlorides and the amount of organic chlorides present in the feedstock.

### EXAMPLES

In the following, the invention is illustrated by the following non-limiting example.

In the illustrative examples, Used Cooking Oil (UCO) is employed. However, the invention is readily applicable on all types of feedstocks as mentioned herein.

### Example 1

UCO (2050, H₂O=0.25%, inorganic Cl=53 ppm, organic Cl 12 ppm) was mixed with a filter aid (magnesium silicate, diatomite product, diatomaceous earth, perlite or cellulose) (0.33 wt %) as bodyfeed at 85° C. for 20 min at 800 mbar pressure and filtered with the same filter aid as precoat. Filtration flux was excellent, filterability resistance was too small to be measured and filtration time to filter 150 g of UCO was below 0.5 min. Residual inorganic chloride in product was 0-2 (5 ppm for diatomaceous earth) ppm and organic chloride 14-18 ppm. Inorganic Cl removal rate>95% (91% for diatomaceous earth). Total chloride reduction 69-78% (68% for diatomaceous earth)

### Example 2

UCO (2149, H₂O=0.55%, inorganic Cl=66 ppm, organic Cl 62 ppm) was mixed with a filter aid magnesium silicate or diatomaceous earth (0.33 wt %) as bodyfeed at 85° C. for 20 min at 800 mbar pressure and filtered with the same filter aid as precoat. Filtration flux was excellent, filterability resistance was too small to be measured and filtration time to filter 150 g of UCO was below 0.5 min. Residual inorganic chloride in products was 21 and 23 ppm and organic chloride 62 and 63 ppm with magnesium silicate and diatomaceous earth, respectively. Inorganic Cl removal rates 65-68%. Total chloride reduction 33-35%.

### Example 3

UCO (2149, H₂O=0.55%, inorganic Cl=66 ppm, organic Cl 62 ppm) was dried separately with rotavapor to water content of 0.16 and 0.21%, mixed with a filter aid magnesium silicate (0.33 wt %) as bodyfeed at 85° C. for 20 min at 800 mbar pressure and filtered with the same filter aid as precoat. Filtration flux was excellent, filterability resistance was too small to be measured and filtration time to filter 150 g of UCO was below 0.5 min. Residual inorganic chloride in products were 15 and 26 ppm, and organic chloride 64 and 65 ppm with 0.16 and 0.21% water containing feeds, respectively. Inorganic Cl removal rates 61-77%. Total chloride reduction 30-38%.

### Example 4

UCO (2065, H₂O=0.93%, inorganic Cl=80 ppm, organic Cl 9 ppm) was mixed with a diatomaceous earth type filter aid (0.33 wt %) as bodyfeed at 85° C. for 20 min at 800 mbar pressure and filtered with the same filter aid as precoat. Filtration flux was excellent, filterability resistance was too small to be measured and filtration time to filter 150 g of UCO was below 0.5 min. Residual inorganic chloride in product 1 ppm and organic chloride 17 ppm. Inorganic Cl removal rate>99%, but increase of organic Cl 89%. Total chloride reduction 80%.

11 out of the 13 filter aids (cellulose, perlite, diatomite product, diatomaceous earth, magnesium silicate, alumino silicate and aluminum oxide) gave good (>80%) inorganic Cl removal rate.

Bleachings of filter aid filtered oil;

### Example 5

UCO (2050, H₂O=0.25%, inorganic Cl=53 ppm, organic Cl 12 ppm) was first filtered with magnesium silicate or diatomaceous earth (see example above) and then bleached with citric acid and acidic bleaching earth Tonsil (1 wt %) as bodyfeed at 85° C. for 20 min at 800 mbar pressure, then at 105° C. for min at 80 mbar and finally filtered with the same bleaching earth as precoat. Residual inorganic chloride in product ˜0 ppm and organic chloride or 17 ppm. Inorganic Cl removal rate>99%. Total chloride reduction was 74-75%. Bleaching filtration time of the 150 g of UCO in reference bleaching with Tonsil was 14 min and filtration resistance was 558 GPas/kg². Bleaching filtration time of 150 g of UCO after filter aid filtration were lowered to 8 and 8 min, and resistances 584 and 383 GPas/kg² (magnesium silicate or diatomaceous earth, respectively).

### Example 6

UCO (2149, H₂O=0.55%, inorganic Cl=66 ppm, organic Cl 62 ppm) was first filtered with diatomaceous earth and then bleached with a citric acid and acidic bleaching earth Tonsil (1 wt %). Residual inorganic Cl in product was 4 ppm and organic Cl 71 ppm. Inorganic Cl removal rate was 94%. Total Cl reduction was 41%. Bleaching filtration time of 150 g of UCO in reference bleaching with Tonsil was 13 min and filtration resistance was 525 GPas/kg² which were reduced to 10 min and to 469 GPas/kg² in bleaching of diatomaceous earth filtered UCO. The best improvement in the bleaching parameters was obtained with the dirtiest UCO (2292, H₂O 3.33%, inorganic Cl=194 ppm, organic Cl=120 ppm) where bleaching filtration time of 150 g of UCO reduced from 46 min to 22 min and the filtration resistance reduced from 11983 to 1738 GPas/kg² when diatomaceous earth filter aid filtration was applied prior to bleaching.

Comparative Examples without employment of filter aid filtration of UCO before bleaching.

### Example 7

UCO (2050, H₂O=0.25%, inorganic Cl=53 ppm, organic Cl 12 ppm) was first mixed with a citric acid and acidic bleaching earth Tonsil (1 wt %) as bodyfeed at 85° C. for 20 min at 800 mbar pressure, then at 105° C. for 10 min at 80 mbar and finally filtered with the same bleaching earth as precoat. Residual inorganic chloride in product ˜0 ppm, but organic chloride 43 ppm. Inorganic Cl removal rate>99%, but increase of organic Cl 258%. Total chloride reduction was only 34%, compared to 75% in a two-stage process with filter aid pre filtration.

### Example 8

UCO (2149, H₂O=0.55%, inorganic Cl=66 ppm, organic Cl 62 ppm) was first mixed with a citric acid and acidic bleaching earth Tonsil (1 wt %) as bodyfeed at 85° C. for 20 min at 800 mbar pressure, then at 105° C. for 10 min at 80 mbar and finally filtered with the same bleaching earth as precoat. Residual inorganic chloride in product 4 ppm, but organic chloride 101 ppm. Inorganic Cl removal rate 94%, but increase of organic Cl 63%. Total chloride reduction was only 18%, compared to 41% in a two-stage process with filter aid pre filtration.

Thus, in conclusion and merely as one example of the effectiveness of the invention, it is clearly illustrated that by the method of present invention, the amount of chloride containing compounds is reduced in comparison to methods which do not employ filter aid filtration, which is illustrated in Table 1.

TABLE 1

| | UCO 2050 with filter | | UCO 2050 without filter | |
|---|---|---|---|---|
| | aid filtration | | aid filtration | |
| | inorg. Cl/ | org. Cl/ | inorg. Cl/ | org. Cl/ |
| | ppm | ppm | ppm | ppm |
| Feed | 53 | 12 | 53 | 12 |
| After filter | 0-2 | 14-18 | | |
| aid filtration | | | | |
| After bleaching | ~0 | 15-17 | ~0 | 43 |

| | | |
|---|---|---|
| Tot Cl after treatment | <18 | 43 |

As is shown in table 1, organic Cl content after bleaching increased by 258% when the method did not include filter aid filtration and only 42% when the method included filter aid filtration prior bleaching.

TABLE 2

| | Dried UCO 2149 (H₂O in | | Undried UCO 2149 (H₂O | |
|---|---|---|---|---|
| | feed 0.16 to 0.21%) | | in feed 0.55%) | |
| | inorg. Cl/ | org. Cl/ | inorg. Cl/ | org. Cl/ |
| | ppm | ppm | ppm | ppm |
| Feed | 66 | 62 | 66 | 62 |
| After filter | 15-26 | 64-65 | 21-30 | 62-63 |
| aid filtration | | | | |

As is shown in table 2, inorganic Cl content after filter aid filtration decreased more when the feed was dried before the filter aid filtration.

TABLE 3

| | Feed ID | | | | | | | |
|---|---|---|---|---|---|---|---|---|
| | UCO 2050 | | | | UCO 2149 | | UCO 2292 | |
| Method | A) | B) | C) | D) | E) | F) | G) | H) |
| Filterability | 558 | 383 | 584 | 408 | 525 | 469 | 11983 | 1738 |
| resistance, | | | | | | | | |
| GPas/kg² | | | | | | | | |
| Filtration | 14 | 8 | 8 | 6.5 | 13 | 10 | 46 | 22 |
| time, min | | | | | | | | |

A) Reference bleaching without prior filter aid filtration
B) Bleaching after diatomaceous earth filter aid filtration
C) Bleaching after magnesium silicate filter aid filtration
D) Bleaching after aluminosilicate filter aid filtration
E) Reference bleaching without prior filter aid filtration
F) Bleaching after diatomaceous earth filter aid filtration
G) Reference bleaching without prior filter aid filtration
H) Bleaching after diatomaceous earth filter aid filtration

As is shown in table 3 the best improvement in the bleaching parameters was obtained with the dirtiest UCO (2292, H₂O 3.33%, inorganic Cl=194 ppm, organic Cl=120 ppm) where bleaching filtration time of 150 g of UCO reduced from 46 min to 22 min and the filtration resistance reduced from 11983 to 1738 GPas/kg² when diatomaceous earth filter aid filtration was applied prior to bleaching.

1-17. (canceled)

18. A process for removal or reduction of inorganic chloride compounds from a feedstock containing a lipid material, the process comprising:
i) providing a feedstock containing a lipid material;
ii) optionally subjecting the feedstock to drying;
iii) mixing said feedstock with a silicon or mineral based material; and
iv) separating the feedstock from the silicon or mineral based material,
wherein the separated feedstock from step iv) is subjected to a bleaching and/or degumming.

19. The process according to claim 18, wherein the feedstock in step i) includes:
an inorganic chloride content of equal to or more than 30 ppm, and/or about 35 ppm; and
a total chloride content equal to or more than about 50 ppm.

20. The process according to claim 18, wherein the lipid material comprises:
one or more of microbial, algae, bacteria, fungal material, any plant oils, plant fats, fish oils, fish fats, animal fats and animal oils, waste fats, waste oils, residue fats, residue oils, and/or mold oils, selected from rapeseed oil, canola oil, colza oil, tall oil, sunflower oil, corn oil, technical/distillers corn oil, soybean oil, hemp oil, olive oil, linseed oil, cottonseed oil, mustard oil, palm oil, palm oil mill effluent oil (POME), and/or sludge originating from and containing any type of plant oil, arachis oil, castor oil, coconut oil, animal fats, suet, tallow, blubber, fish oil, recycled alimentary fats, used cooking oil (UCO), acidulated soapstock (acidified soapstock, SAO), trap grease, brown grease, gutter oil, Fatty Acid Distillates (FAD) from rice bran oil and/or from palm oil (palm oil fatty acid distillate PFAD), genetically engineered starting material, and/or biological starting material containing material from microbes, algae, bacteria and/or the like, and/or any combinations and/or mixtures thereof.

21. The process according to claim 18, wherein the silicon or mineral based material is selected from at least one or more of:
silicon oxide based compounds, silicon dioxide based compounds, silica gels or silica xerogels in any form or configuration, silica alumina gel, diatomaceous earth, diatomite, perlite or cellulose based materials, magnesium silicate, silicon, aluminium and/or zinc oxide based materials, neutral bleaching earth, and/or any combinations thereof.

22. The process according to claim 18, wherein the feedstock in step iii) is contacted with the silicon or mineral based material at a temperature in a range of about 15° C. to about 120° C., and/or about 50° C. to about 90° C., about 60° C. to about 95° C., and/or about 70° C. to about 90° C., and/or about 80° C. to about 90° C., and/or about 85° C.

23. The process according to claim 18, wherein the silicon or mineral based material is combined with a filter device selected from at least one or more of:
a grid, a net, a porous glass disk, a paper/cellulose based material, a membrane of any kind or based on any material, and/or a polymer based membrane.

24. The process according to claim 18, wherein separation in step iv) takes place by at least one or more of:
filtration, settling, decantation, centrifugation, and the like, and/or any combinations thereof.

25. The process according to claim 18, wherein the contacting in step iii) takes place under a pressure of at least one or more of:
about 1000 mbar or below, below about 1000 mbar, about 900 mbar, about 800 mbar, about 700 mbar, about 600 mbar, about 500 mbar, about 400 mbar, about 300 mbar, about 200 mbar, about 100 mbar, and/or under any pressure in range of about 100 mbar to about 1000 mbar.

26. The process according to claim 18, wherein the contacting in step iii) takes place during any time period or interval a least one or more of: about 1 min to 360 min, 5 min to about 40 min, about 10 min to about 30 min, about 15 min to about 25 min, and/or about 20 min.

27. The process according to claim 18, wherein the feedstock in i) comprises:
at least one or more inorganic chloride compounds in an amount of about 100 ppm or less, about 90 ppm or less, about 80 ppm or less, about 70 ppm or less, about 60 ppm or less, about 50 ppm or less, and/or about 40 ppm or less.

28. The process according to claim 18, wherein the feedstock after separation in step iv) displays a reduced amount of inorganic chloride compounds by at least about 10%, at least about 20%, at least about 30%, at least about 50%, at least about 60%, and/or is essentially free of any of inorganic chloride compounds.

29. The process according to claim 18, wherein step ii) comprises:
treating the feedstock with an acidic medium, an organic acid (citric acid) and/or with acidic bleaching earth.

30. The process according to claim 18, wherein the bleaching and/or degumming treatment procedure after step iv) comprises one or more of:
a) additional heating in range of about range of about 15° C. to about 120° C., about 50° C. to about 90° C., about 60° C. to about 95° C., about 70° C. to about 90° C., about 80° C. to about 90° C., about 85° C., and/or about 105° C.,
b) performing the additional treatment for 1 min to 360 min, for 5 min to about 40 min, for about 10 min to about 30 min, for about 15 min to about 25 min, and/or for about 10 min,
c) performing the additional treatment under reduced pressure, and/or in range of about 1 mbar to about 300 mbar, about 10 mbar to about 100 mbar, and/or about 80 mbar.

31. The process according to claim 23, wherein the filter device is pre-coated with the silicon or mineral based material.

32. The process according to claim 18, wherein the contacting in step iii) comprises:
contacting the feedstock with a silicon or mineral based material in an amount of 0.1 wt % to 5 wt % based on a content of a weight of the feedstock, and the contacting takes place in a temperature range of 15° C. to 120° C., for a period of time 1 minute to 360 min, and at a reduced pressure of about 1000 mbar or below 1000 mbar.

33. A purified feedstock obtainable by the process according to claim 18, wherein the feedstock comprises:
an inorganic chloride content in range of from equal or less than about 10 ppm to levels which cannot be analytically detected.

34. The purified feedstock according to claim 33, wherein the organic chloride content is not increased by more than 10 ppm in comparison with unpurified feedstock according to claim 1 i).

35. The process according to claim 19, wherein the lipid material comprises:
one or more of microbial, algae, bacteria, fungal material, any plant oils, plant fats, fish oils, fish fats, animal fats and animal oils, waste fats, waste oils, residue fats, residue oils, and/or mold oils, selected from rapeseed oil, canola oil, colza oil, tall oil, sunflower oil, corn oil, technical/distillers corn oil, soybean oil, hemp oil, olive oil, linseed oil, cottonseed oil, mustard oil, palm oil, palm oil mill effluent oil (POME), and/or sludge originating from and containing any type of plant oil, arachis oil, castor oil, coconut oil, animal fats, suet, tallow, blubber, fish oil, recycled alimentary fats, used cooking oil (UCO), acidulated soapstock (acidified soapstock, SAO), trap grease, brown grease, gutter oil, Fatty Acid Distillates (FAD) from rice bran oil and/or from palm oil (palm oil fatty acid distillate PFAD), genetically engineered starting material, and/or biological starting material containing material from microbes, algae, bacteria and/or the like, and/or any combinations and/or mixtures thereof.

36. The process according to claim 35, wherein the silicon or mineral based material is selected from at least one or more of:
silicon oxide based compounds, silicon dioxide based compounds, silica gels or silica xerogels in any form or configuration, silica alumina gel, diatomaceous earth, diatomite, perlite or cellulose based materials, magnesium silicate, silicon, aluminium and/or zinc oxide based materials, neutral bleaching earth, and/or any combinations thereof.
